(19) United States
(12) Patent Application Publication
(10) Pub. No.: US 2003/0099330 A1
(43) Pub. Date: May 29, 2003

(54) Method for automatically detecting casting defects in a test piece

(76) Inventors: Domingo Mery, La Luna (CL); Dieter Filbert, Berlin (DE)

Correspondence Address: Richard S Roberts, Roberts & Mercanti, PO Box 484, Princeton, NJ, 08542-0484, US

(21) Appl. No.: 10/182,861

(22) PCT Filed: Jan. 8, 2001
(86) PCT No.: PCT/EP01/00123

(30) Foreign Application Priority Data
Feb. 5, 2000 (EP) 00102507.1

(51) Int. Cl. H05G 1/00

(52) U.S. Cl. 378/210

(57) ABSTRACT

The invention relates to a novel method for automatically inspecting, e.g., aluminium cast parts using a monocular sequence of X-ray images taken of the test piece in different positions. Known methods for the automatic detection of casting defects use modified median filters which estimate X-ray images that are free of defects using recorded X-ray images. These images are compared with each other and casting defects are detected when a particularly great difference exists between them. However, the configuration of each filter depends to a considerable extent on the size, shape and position of the constructional structure of the test piece. These characteristics of the test piece therefore have to be considered a priori. The invention provides a method enabling casting defects to be automatically detected in two steps. The method uses a single filter and no a priori knowledge of the structure of the test piece. Aside from calibration, the first step of the method segments hypothetical casting detects in each image in the sequence. The second step entails trying to trace the hypothetical casting defects in the image sequence. The basic idea behind the inventive method is the assumption that the hypothetical casting defects that cannot be traced in the sequence are detection errors. By using this method it is possible to detect true casting defects with maximum probability and eliminate detection errors. The process of tracing the hypothetical casting defects in the image sequence is carried out according to the principles of multiple image analysis. Bifocal, trifocal and quadrifocal tensors are used to reduce the calculation time. A 3D-reconstruction is produced of the hypothetical casting defects traced in the image sequence, enabling those which do not belong to the test piece space to then be eliminated. The robustness and reliability of the method are checked with semi-synthetic and real X-ray image sequences taken of an aluminium rim with known material defects. The true casting defects are detected and the detection errors are eliminated.

The invention relates to a method for automatically detecting casting defects in a test piece according to the preamble of the main claim.

Such methods are known in various procedural modes. The publications of the present invention, which are carried out in the appended literature references under [12]-[14], are viewed as the nearest prior art.

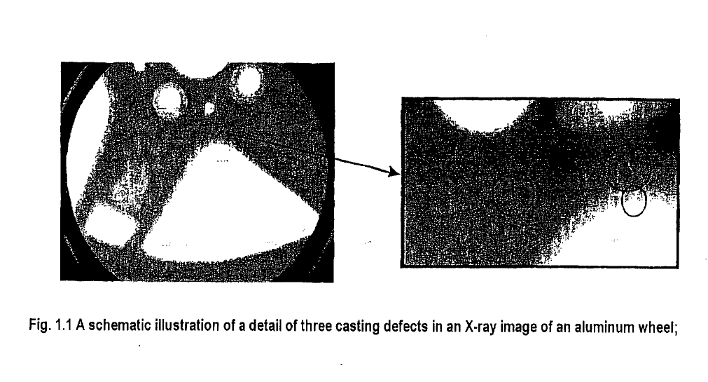

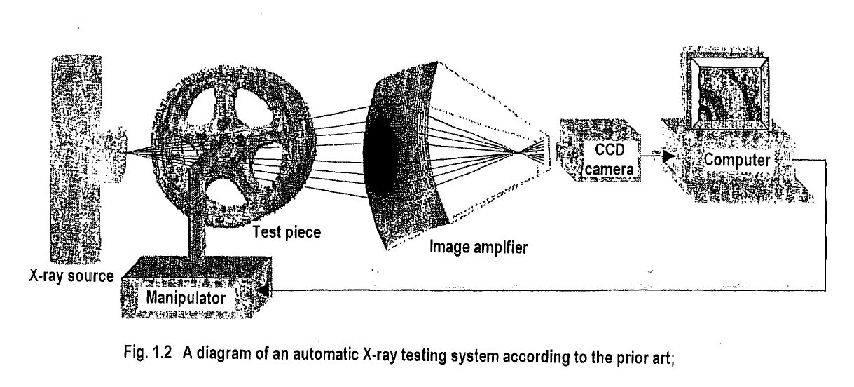

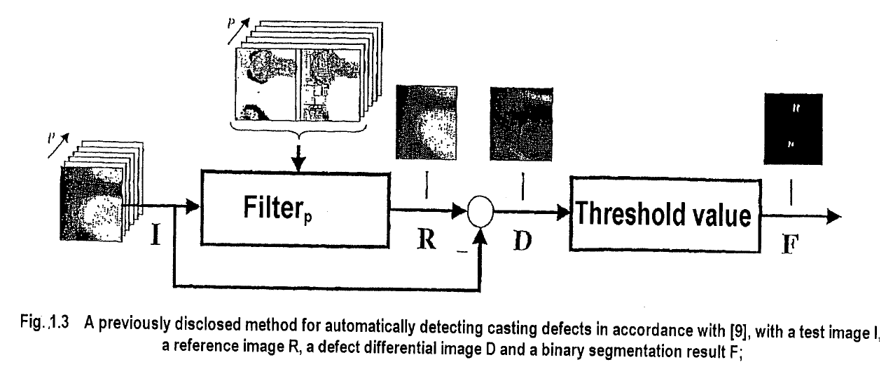

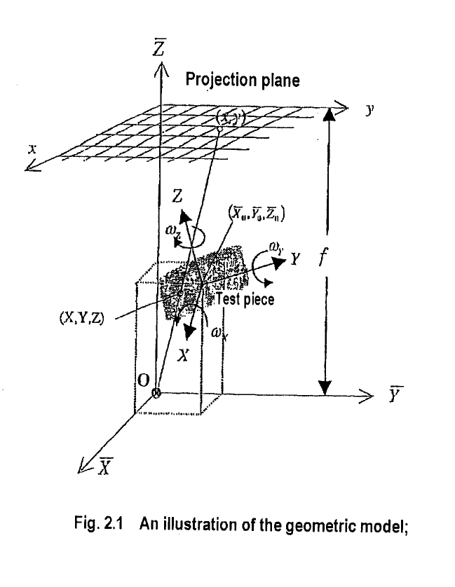

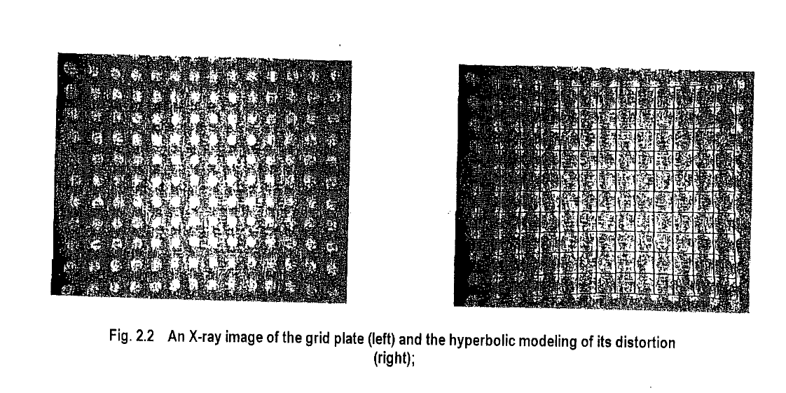

The quality inspection of cast parts is carried out with the aid of X-ray transillumination testing. Its task is to look for casting defects, which are located in the interior of the part and thus cannot be registered visually from the outside. During the fabrication of cast parts, shrinkage processes can occur when liquid metal solidifies as a result of cooling. Voids occur in the interior of the workpiece when no liquid metal can continue to flow. Added to this are other casting defects in the casting process, such as inclusions and slags. One example is shown in FIG. 1.1.

For some years, X-ray testing systems have been used in the automobile industry in order to carry out the quality inspection of cast parts automatically [1, 6, 10]. An automatic X-ray testing system, as illustrated in FIG. 1.2, comprises:

i) a manipulator for handling the test piece,

ii) an X-ray source, which produces an X-ray image of the test piece via central projection,

iii) an image amplifier, which converts the invisible X-ray image into a visible image,

iv) a CDD camera, which records the visible X-ray image, and

v) an image processing computer, whose task is the automatic classification of the test piece in the cast part or reject part by processing the X-ray image.

In accordance with the classical methods, in X-ray transillumination testing, as a rule monocular projections are recorded from various positions of the test piece. The detection approaches used in practice [15, 10, 9, 17] calculate a reference image from each X-ray image recorded. A casting defect is then detected when a large difference occurs between the X-ray image and reference image (see FIG. 1.3). In the case of this method, each recording has its own filter, which comprises a plurality of small windows. The direction and size of this window are set in such a way that the filter is matched to the structure of the test piece at the corresponding position of the recording. These methods differ in the type of filtering which is applied in order to calculate the reference image. Disadvantages for classical methods are:

configuration of the filter: in order to examine a cast part, the test piece generally has to be X-rayed in about 20 positions. A filter has to be configured for each position. In practice, this configuration is very complicated, since it has to be carried out manually. The setting of the filters of a very complex cast part can last for up to four weeks. Since the filters determined are matched to the structure of a test piece they cannot logically be used for test pieces of a different structure.

Failure of the filtering in the event of positioning inaccuracy: the estimation of a fault-free reference image fails when there is a large deviation between desired and actual position of the test piece, since the matching of the set filter to the structure can no longer be satisfied. This problem occurs not infrequently during the movement of a cast part to the programmed positions, since the several braking and acceleration actions of the manipulator can lead to the cast part slipping.

No application of the correspondence between X-ray images: these methods look for material defects in each digitized X-ray image, without taking account of the fact that the defects can appear in a plurality of projections. The information relating to the position of the test piece, which is normally available in each manipulator, can be used to find correspondence between the recorded X-ray images. In this way, it is possible to find out whether the defects detected in the individual images are true casting defects or erroneous detections.

The evaluation of X-ray image sequences is also already known. The method is based on the way in which a tester examines a cast part for material defects. Instead of individual images, he considers an image sequence. The test piece is moved in the testing system and the eyes of the tester track the details which appear on the monitor. A casting defect is detected when the eyes can track the fault in the image sequence. This method permits humans to examine each test piece irrespective of the constructive structure of the cast part.

In this case, a single filter is used for the detection of hypothetical casting defects in each X-ray image of a sequence from the test piece. The configuration of the filter depends on the constructive structure and the position of the test piece. The number of segmented hypothetical casting defects is not low but, during the attempt to track the hypothetical casting defects in the image sequence, the erroneous detections may be eliminated without discriminating the true casting defects.

This method has already been proposed in [12], in that two approaches [13, 14] to tracking hypothetical casting defects in an image sequence has been developed:

Method A: Because of the rotational movement of the test piece, those hypothetical casting defects which do not form elliptical trajectories in the image sequence are removed [14].

Method B: With the aid of epipolar geometry [3], a check is made in a plurality of images to see whether the points of a formed trajectory correspond with one another [13].

However, the discrimination of non-elliptical trajectories in [14] is less robust. In addition, the calculation of the points of the trajectories [13] from three or four images cannot be carried out directly through the epipolar conditions. The estimation of the point of intersection of epipolar straight lines in more than two views is not defined in some cases [5]. A detection of casting defects is therefore time-consuming and not sufficiently robust.

The invention is therefore based on the object of increasing the robustness of the same and reducing erroneous detections.

According to the invention, this object is achieved by the method mentioned at the beginning, as characterized in claim 1.

The problems mentioned are therefore overcome in particular by means of the calibration of the system, specific search for defective areas and the application of the bifocal, trifocal and quadrifocal tensors. The tracking of the hypothetical casting defects in the image sequence is carried out in accordance with the principle of multiple-image analysis. The fundamentals of multiple-image tensors can be found in [5, 7, 8, 11, 16].

Further advantages and features emerge from the subclaims, which can also be of inventive significance jointly with the main claim. In the following text, a preferred exemplary embodiment will be explained in more detail by using the drawings, to which the invention is not restricted, however. In the drawings:

FIG. 1.1 shows a schematic illustration of a detail of three casting defects in an X-ray image of an aluminum wheel;

FIG. 1.2 shows a diagram of an automatic X-ray testing system according to the prior art;

FIG. 1.3 shows a previously disclosed method for automatically detecting casting defects in accordance with [9], with a test image I, a reference image R, a defect differential image D and a binary segmentation result F;

FIG. 2.1 shows an illustration of the geometric model;

FIG. 2.2 shows an X-ray image of the grid plate (left) and the hyperbolic modeling of its distortion (right);

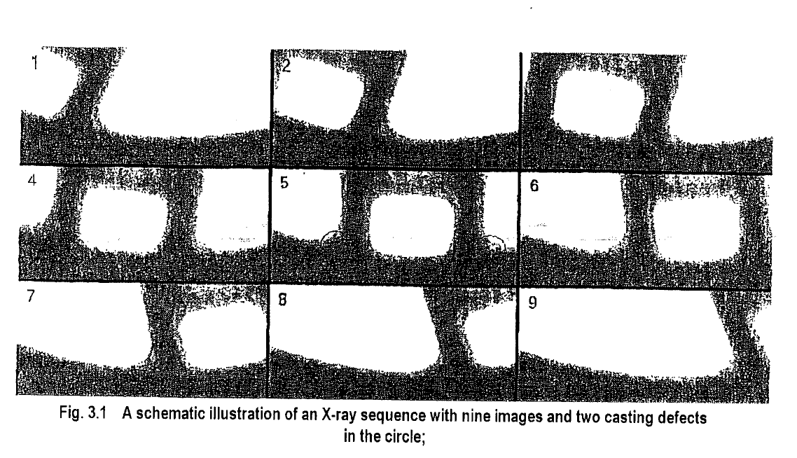

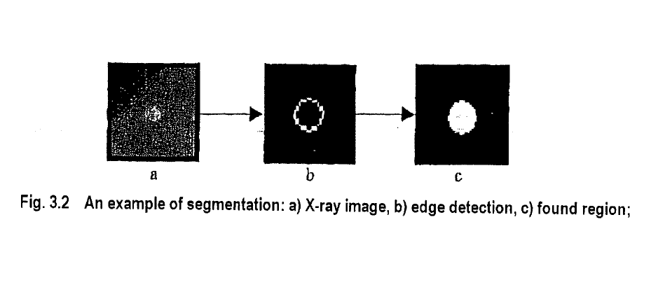

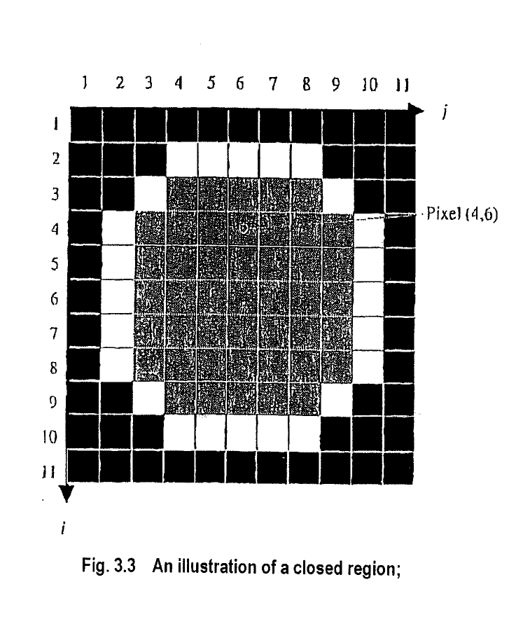

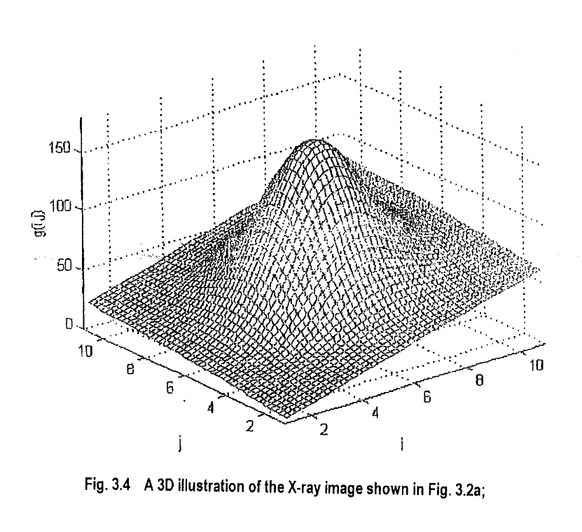

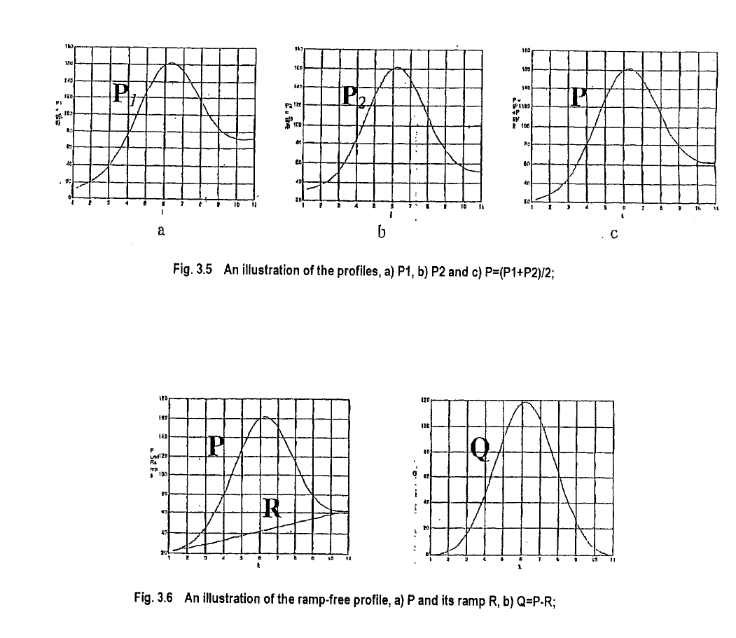

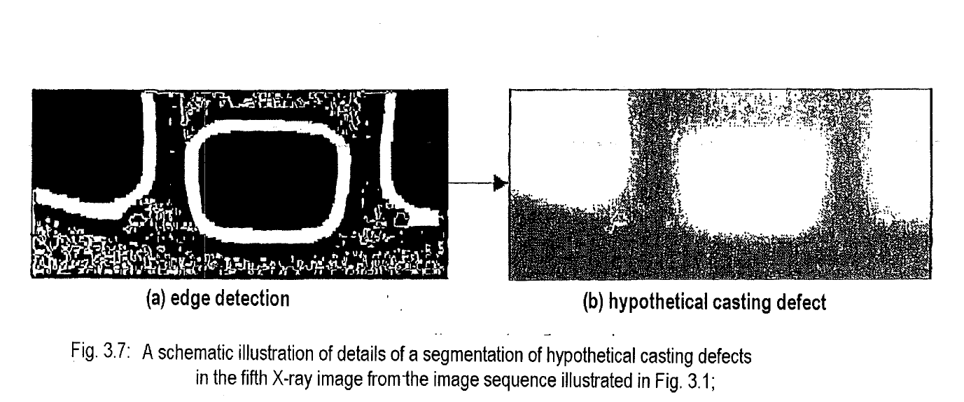

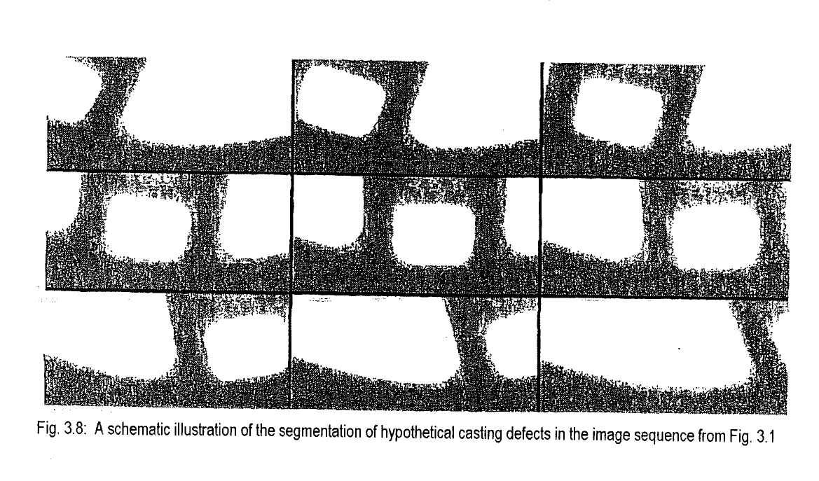

FIG. 3.1 shows a schematic illustration of an X-ray sequence with nine images and two casting defects in the circle;

FIG. 3.2 shows an example of segmentation: a) X-ray image, b) edge detection, c) found region;

FIG. 3.3 shows an illustration of a closed region;

FIG. 3.4 shows a 3D illustration of the X-ray image shown in FIG. 3.2a;

FIG. 3.5 shows an illustration of the profiles, a) P₁, b) P₂ and c) P=(P₁+P₂)/2;

FIG. 3.6 shows an illustration of the ramp-free profile, a) P and its ramp R, b) Q=P−R;

FIG. 3.7 shows a schematic illustration of details of a segmentation of hypothetical casting defects in the fifth X-ray image from the image sequence illustrated in FIG. 3.1;

FIG. 3.8 shows a schematic illustration of the segmentation of hypothetical casting defects in the image sequence from FIG. 3.1;

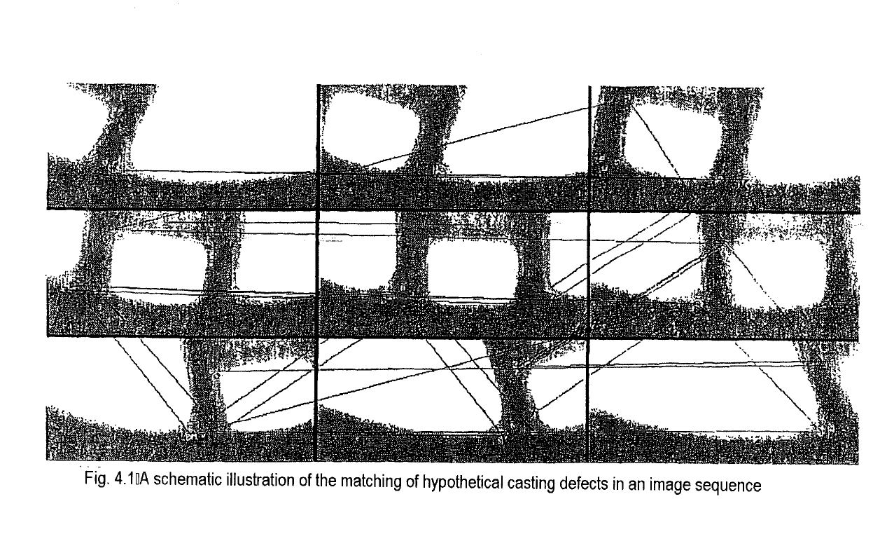

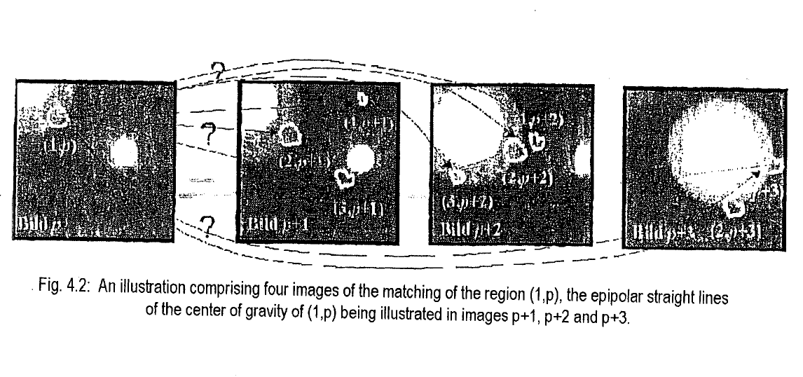

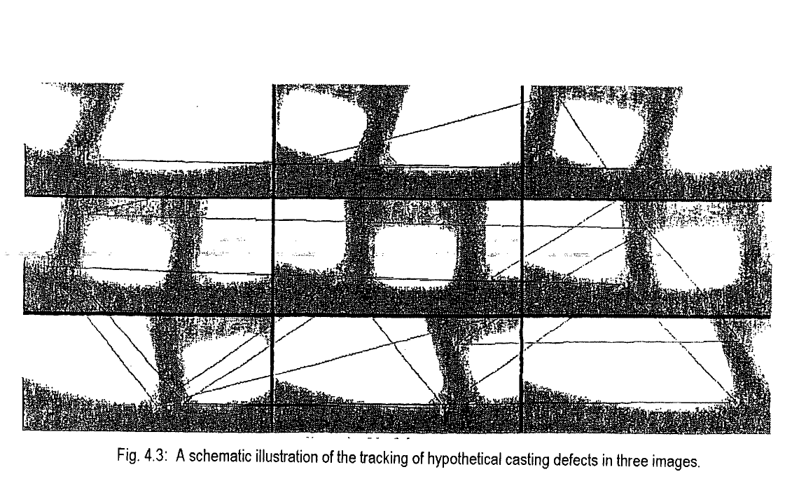

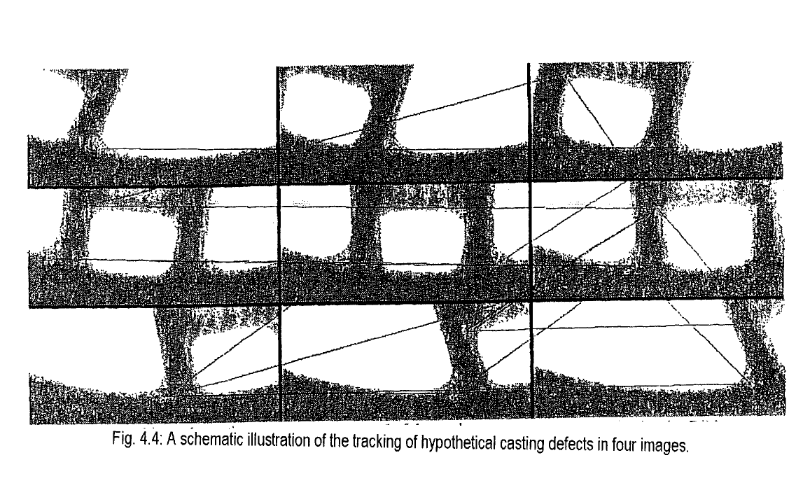

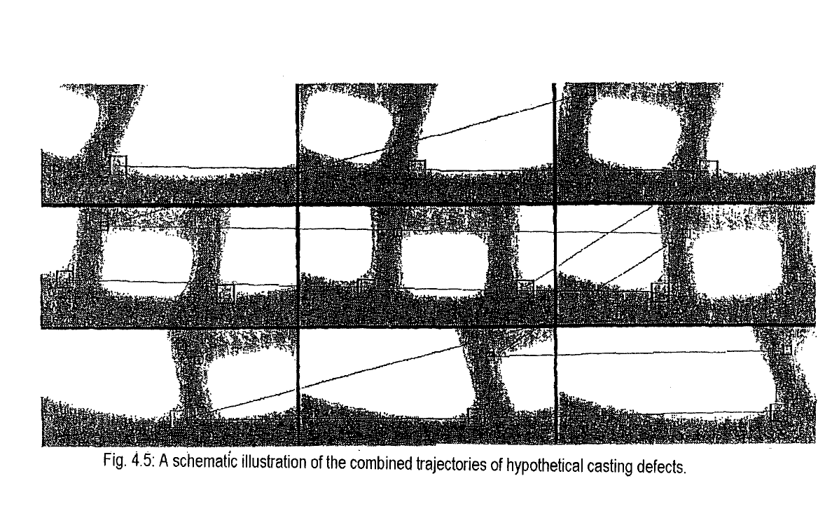

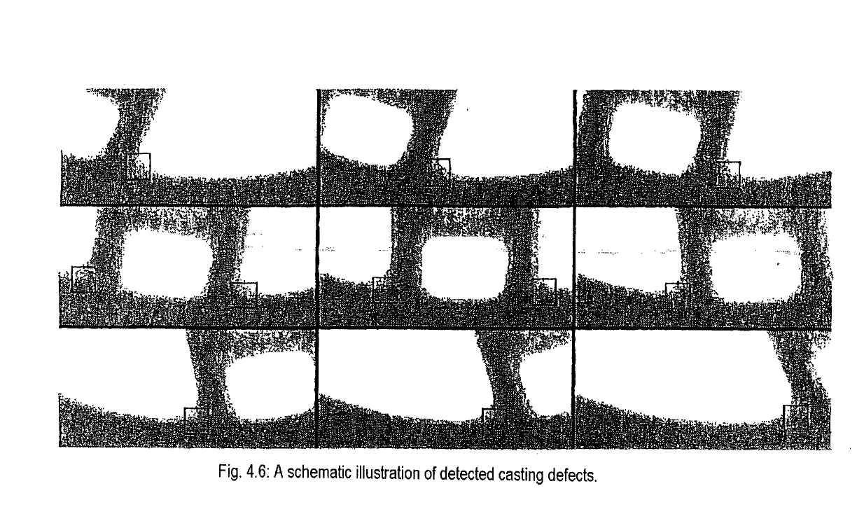

FIG. 4.1 shows a schematic illustration of the matching of hypothetical casting defects in an image sequence;

FIG. 4.2 shows an illustration comprising four images of the matching of the region (1,p), the epipolar straight lines of the center of gravity of (1,p) being illustrated in images p+1, p+2 and p+3;

FIG. 4.3 shows a schematic illustration of the tracking of hypothetical casting defects in three images;

FIG. 4.4 shows a schematic illustration of the tracking of hypothetical casting defects in four images;

FIG. 4.5 shows a schematic illustration of the combined trajectories of hypothetical casting defects;

FIG. 4.6 shows a schematic illustration of detected casting defects;

Table 5.1 shows detection in real X-ray image sequences;

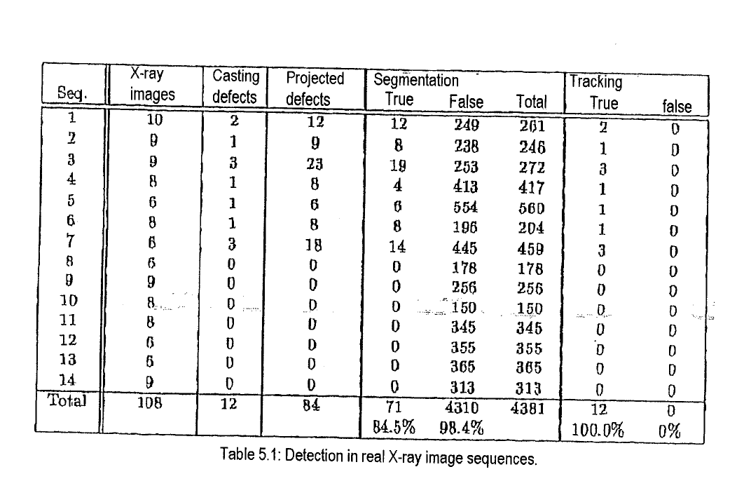

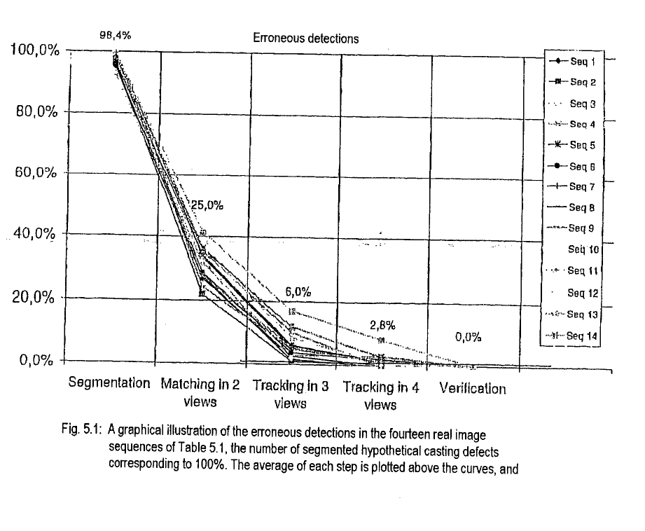

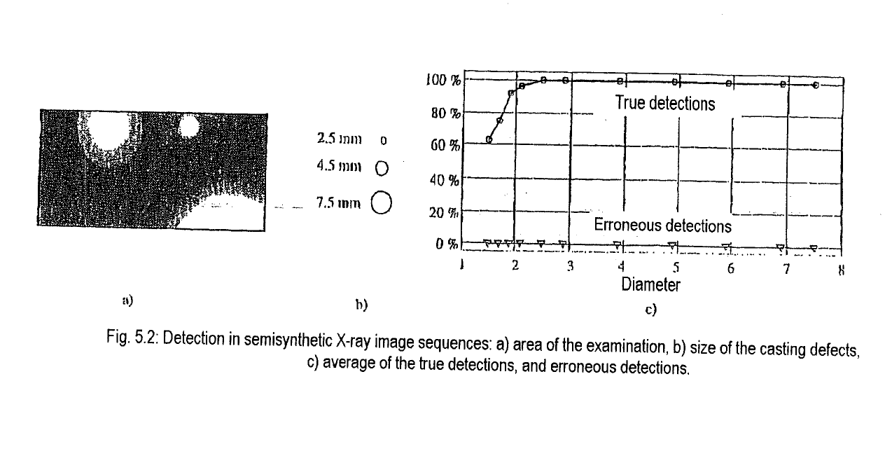

FIG. 5.1 shows a graphical illustration of the erroneous detections in the fourteen real image sequences of Table 5.1, the number of segmented hypothetical casting defects corresponding to 100%. The average of each step is plotted above the curves, and

FIG. 5.2 shows detection in semisynthetic X-ray image sequences:

a) area of the examination,

b) size of the casting defects,

c) average of the true detections, and erroneous detections.

The method according to the invention in principle comprises three sections: calibration of testing system and camera, recording and segmentation, and tracking hypothetical casting defects and their analysis.

In the following text, the intention is to discuss further the first step of the method according to the invention. This is a calibration which takes place off line, the relevant geometric parameters of the method being measured or estimated. For this purpose, firstly the entire geometry of the testing system is measured, specifically with regard to its length, width and height, and also the distances between the individual devices. Particular values do not have to be complied with here, but determined by measurement. The aim of the calibration is to determine the transformation between a 3D point on the casting part and the 2D pixel in the X-ray image.

The position of the test piece is defined by the translational and rotational positional variables of the manipulator. The translational variables (\overline{X}₀,\overline{Y}₀,\overline{Z}₀) (see FIG. 2.1) represent the position of the center of the test piece, based on the position of the X-ray source o. The rotational variables (ωₓ, ω_{y}, ω_{z}) (see FIG. 2.1) represent the rotation of the test piece about the X-, Y- and Z-axes. These measured variables are available in the manipulator. The variables (\overline{X}₀,\overline{Y}₀,\overline{Z}₀) are specified in millimeters, and the variables (ωₓ, ω_{y}, ω_{z}) in degrees.

In this application, homogeneous coordinates are used to represent points [2]. A 3D test piece point is designated X=[X Y Z 1]^{T} in an object coordinate system which is linked with the moving object. This means that these coordinates are independent of the movement of the test piece.

In order to determine the transformation, firstly X is projected linearly onto the projection plane (x, y) (see FIG. 2.1). The projection plane is located at rightangles to the optical axis at the input of the image amplifier. The relationship between a point X=[X Y Z 1]^{T} of the test piece and its projection on the projection plane x=[x y 1]^{T} is described by the following linear equation:

$$λ [ \begin{matrix}x \\ y \\ 1\end{matrix} ] = [ \begin{matrix}{P}_{11} & {P}_{12} & {P}_{13} & {P}_{14} \\ {P}_{21} & {P}_{22} & {P}_{23} & {P}_{24} \\ {P}_{31} & {P}_{32} & {P}_{33} & {P}_{34}\end{matrix} ] [ \begin{matrix}X \\ Y \\ Z \\ 1\end{matrix} ] or λ x = PX \qquad ( \text{2-1} )$$

where λ is a scaling factor. The matrix P is calculated for each position of the test piece from the focal distance f, the translational and rotational position variables:

$$P = [ \begin{matrix}f & 0 & 0 & 0 \\ 0 & f & 0 & 0 \\ 0 & 0 & 1 & 0\end{matrix} ] [ \begin{matrix}{R}_{11} & {R}_{12} & {R}_{13} & \overline{{X}_{0}} \\ {R}_{21} & {R}_{22} & {R}_{23} & \overline{{Y}_{0}} \\ {R}_{31} & {R}_{32} & {R}_{33} & \overline{{Z}_{0}} \\ 0 & 0 & 0 & 1\end{matrix} ] \qquad ( \text{2-2} )$$

where the elements of the 3×3 matrix R are defined as follows:

R₁₁=cos(ω_{y})*cos(ω_{z})

R₁₂=−cos(ω_{y})*sin(ω_{z})

R₁₃=−sin(ω_{y})

R₂₁=−sin(ωₓ)*sin(ω_{y})*cos(ω_{z})+(ωₓ)*sin(ω_{z})

R₂₂=sin(ωₓ)*sin(ω_{y})*sin(ω_{z})+cos (ωₓ)*cos(ω_{z})

R₂₃=−sin(ωₓ)*cos(ω_{y})

R₃₁cos(ωₓ)*sin(ω_{y})*cos(ω_{z})+sin(ωₓ)*sin(ω_{z})

R₃₂=−cos(ωₓ)*sin(ω_{y})*sin(ω_{z})+sin(ωₓ)*cos(ω_{z})

R₃₃=cos(ωₓ)*cos(ω_{y}) (2-3)

In radioscopy, however, the X-ray image is projected onto a curved image amplifier (see FIG. 1.2). In this case, the projection is nonlinear. As an example, the image in FIG. 2.2 represents the X-ray image of a regular grid plate. It can be seen that the further from the center of an image a hole is located in the grid plate, the more severe is its projective distortion. The reason for this is that the deviation from the normal direction of the surface of the image amplifier from the direction of the optical axis is greatest at the corners.

The relationship between a point (x, y) on the projection plane and a pixel (u, v) in the X-ray image is nonlinear, because of the aforementioned curvature of the image amplifier:

$$[ \begin{matrix}x \\ y \\ 1\end{matrix} ] = [ \begin{matrix}{f}_{1} ( u , v ) \\ {f}_{2} ( u , v ) \\ 1\end{matrix} ] or x = f ( u ) \qquad ( \text{2-4} )$$

where x=[x y 1]^{T} and u=[u v 1]^{T}. In this method, the nonlinear function f is modeled as hyperbolic [12]. First of all, an affine transformation (rotation, translation and scaling) of the image coordinates is carried out:

$$[ \begin{matrix}{u}^{′} \\ {v}^{′} \\ 1\end{matrix} ] = {[ \begin{matrix}{k}_{x} cos ( α ) & {k}_{y} sin ( α ) & {u}_{0} \\ - {k}_{x} sin ( α ) & {k}_{y} cos ( α ) & {v}_{0} \\ 0 & 0 & 1\end{matrix} ]}^{- 1} [ \begin{matrix}u \\ v \\ 1\end{matrix} ] \qquad ( \text{2-5} )$$

After that, the coordinates of the projection plane are calculated:

$$x = \frac{{u}^{′}}{\sqrt{1 + {[ \frac{{u}^{′}}{a} ]}^{2} + {[ \frac{{v}^{′}}{b} ]}^{2}}} and y = \frac{{v}^{′}}{\sqrt{1 + {[ \frac{{u}^{′}}{a} ]}^{2} + {[ \frac{{v}^{′}}{b} ]}^{2}}} \qquad ( \text{2-6} )$$

The transformation of a 3D point from the cast part X=[X Y Z 1]^{T} into a 2D pixel of the X-ray image u=[u v 1]^{T} is therefore carried out in three steps:

if X is multiplied by the projection matrix P in (2-1), the coordinates (x, y) are obtained.

The back-transformation of (2-6) supplies the coordinates (u′, v′):

$${u}^{′} = \frac{x}{\sqrt{1 - {[ \frac{x}{a} ]}^{2} - {[ \frac{y}{b} ]}^{2}}} and {v}^{′} = \frac{y}{\sqrt{1 - {[ \frac{x}{a} ]}^{2} - {[ \frac{y}{b} ]}^{2}}} \qquad ( \text{2-7} )$$

From the back-transformation of (2-5), the coordinates of the pixel (u, v) are obtained:

$$[ \begin{matrix}u \\ v \\ 1\end{matrix} ] = [ \begin{matrix}{k}_{x} cos ( α ) & {k}_{y} sin ( α ) & {u}_{0} \\ - {k}_{x} sin ( α ) & {k}_{y} cos ( α ) & {v}_{0} \\ 0 & 0 & 1\end{matrix} ] [ \begin{matrix}{u}^{′} \\ {v}^{′} \\ 1\end{matrix} ] \qquad ( \text{2-8} )$$

For the purpose of calibration, N=5 X-ray images of the test piece are recorded from various positions. The aluminum wheel is rotated through 5° on the Z axis each time. During each recording, the exact position and rotation of the test piece is registered from the manipulator. From this information, the projective matrices Pₚ (for 1≦p≦N) are calculated. The parameters a and b of the hyperbolic model (see equations (2-6) and (2-7)) and also the parameters α, u₀, v₀, kₓ and k_{y} of the affine transformation (see equations (2-5) and (2-8)) have to be estimated from correspondence points of the X-ray images, with the aid of a gradient method. Here, usual values lie in the range of:

| Para- | | | | | | | | |
|---|---|---|---|---|---|---|---|---|
| meter | α | u₀ | v₀ | a | b | kₓ | k_{y} | f |
| Value | −90° | 280 | 380 | 330 | 360 | 2 pixel/ | 2 pixel/ | 885 |
| | | pixel | pixel | mm | mm | mm | mm | mm |

Trials have shown that a calibration of this type is absolutely necessary when operating methods according to the invention.

In the following text, the recording and segmentation of hypothetical casting defects will be discussed in more detail:

The camera records the X-ray image supplied by the image amplifier and supplies the analog video signal to a computer. The frame-grabber card of the computer scans it and forms a sequence of digitized X-ray images, which are stored on the computer. The image sequence is recorded from various positions of the test piece, without integration. The test piece is rotated through 5°, for example, each time. Other angles are conceivable. An image sequence is shown in FIG. 3.1.

For the purpose of tracking, it is necessary to register the exact position at which the test piece is located at the instant of recording. This information is available online in the manipulator. The position of the test piece is defined by the translational and rotational position variables. The translational variables (\overline{X}₀,\overline{Y}₀,\overline{Z}₀) and the rotational variables (ωₓ,ω_{y}, ω_{z}), which were defined above (see FIG. 2.1) have to be stored in the case of each recording.

In the following text, the algorithm which has been developed for the segmentation of hypothetical casting defects will be explained. In each image in the sequence, regions are looked for which could be true defects. In this step, the correspondence between images is not yet taken into account. The algorithm comprises two steps: edge detection and search for the regions. The segmentation method will be explained again with the aid of a simple example. The example shows how a casting defect in an X-ray image (see FIG. 3.2a) is segmented.

During edge detection, the edges of each X-ray image in the sequence are detected. The edges correspond to the contours at which considerable changes in the gray values occur in the X-ray image. In this study, an edge detection method based on Laplacian-of-Gaussian (LoG) was applied [2, 3], which detects the zero crossings of the second derivative of the image after low-pass Gaussian filtering. As a reminder: the zero crossing of the second derivative of a function corresponds to the maximum or minimum of the first derivative of the function (the first derivative is also called the gradient). Suppressing the quantum noise of the X-ray images is carried out by means of this low-pass Gaussian filtering. The resulting binary image has closed and connected contours as the true casting defects, said contours defining regions. In order to increase the number of closed regions, for this purpose the pixels are marked at which the gradient is greater than a threshold value. The result obtained from this step is a binary image, which is shown in FIG. 3.2b.

During the segmentation of the regions, features are extracted from the regions formed by the edges. A region is classified as a hypothetical casting defect if its feature values are located between specific threshold values. The search of the regions is therefore done by means of the extraction of features and classification.

In the following text, the features applied in this method will be defined and then the classification algorithm will be described.

A region is understood to mean that amount of pixels which, in a binary image, are bounded by edges. The region of our example is composed of the pixels which belong to the circle. An enlargement of FIG. 3.2b is shown in FIG. 3.3, the pixels of the region having been marked in gray. The outer boundary of the region defines the limit of the region (see white pixels in FIGS. 3.2b and 3.3).

In this method, five features are extracted which are referred to a region. The features are:

area size (A),

roundness or shape factor (R),

average of the gray values (G),

average of the gradients at the limit (H) and

contrast (K).

The area size (A) is defined as the number of pixels in the region. In this example, the area size is the number of gray pixels, that is to say A=45 pixels.

The roundness (R) is a measure of the shape of the region. R lies between 1 and 0. For a circle, R=1 and for a region without height or without width, R=0. In order to determine the roundness, first of all the circumference (L) of the region is calculated as the number of pixels at the limit. For the region in FIG. 3.3, L is the number of white pixels, that is to say L=24. The roundness is defined [2] as

$$R = \frac{4 π A}{{L}^{2}} \qquad ( \text{3-1} )$$

In our example, R=4×3, 1416×45/24²=0.98.

The average of the gray values of the region (G) is:

$$G = \frac{1}{A} {\sum }_{i , j ∈ R} {g}_{ij} \qquad ( \text{3-2} )$$

and in this case:

→gᵢⱼ is the gray value of the pixel (i, j), and

→R is the pixel set in the region. In the example of FIG. 3.3, the pixel (4, 6) is a pixel in this set. The number of pixels in the set R is A, that is to say the area size of the region.

In our example, G=121.90 (G=0 means 100% black and G=255 corresponds to 100% white).

The average of the gradient at the limit (H) is defined as

$$H = \frac{1}{L} {\sum }_{i , j ∈ λ} {g}_{ij}^{′} \qquad ( \text{3-3} )$$

and in this case:

→g′ᵢⱼ is the gradient (first derivative) of the gray value of the pixel (i, j), and

→λ is the pixel set at the limit (white pixels in FIG. 3.3). The number of pixels in the set λ is L, that is to say the circumference of the region.

In our example, H=35.47.

In the following text, the feature contrast (K) is defined. The contrast of the region is understood to mean a dimension of the blackening difference between region and its surroundings. In this study, region and surroundings define a field. The lower the gray value differences in a field are, the lower is the contrast. In order to visualize the contrast, the gray values of the field can be represented as a 3D function, by the x- and y-axis representing the coordinates of a pixel in the i direction and j direction, and the z axis being the gray value gᵢⱼ of the pixel (i, j) . FIG. 3.4 shows this representation for our example from FIG. 3.2a. It can be seen that this is a contrasty region, since the height of the curve is large.

The contrast has been defined mathematically in various ways. Some definitions lead to a great deal of computing time (see textures in [2]). Other simpler definitions, such as the difference between the maximum and minimum of the gray values, are very sensitive to noise, however. For this reason, in this study a new method of calculating the contrast is used, which is not time-consuming. The method will be explained in the following text:

1) Profile of the field: the average P is calculated from two profiles P₁ and P₂, the gray values of the field: the first profile P₁ in the i direction and the second P₂ in the j direction. Both profiles are centered at the center of gravity of the region. In our example, the center of gravity is at (6,6), that is to say P₁ and P₂ are the gray values of the 6th column and the 6^{th} row of the X-ray image. A representation of P₁, P₂ and of the average P shown in FIG. 3.5.

P₁=profile of the field in the i direction

P₂=profile of the field in the j direction

P=(P₁+P₂)/2 (3-4)

2) Isolating the defect: In order to isolate the defect, its background is eliminated, which is modeled as a ramp. It is assumed that the extreme values of P belong to the ramp. The ramp is extracted from P. In FIG. 3.6, the new profile Q is determined.

R=ramp (P)

Q=P−R (3-5)

3) Calculating the contrast: the contrast K is then defined as the standard deviation of the ramp-free profile divided by the length of the profile. That is to say

$$K = \frac{{σ}_{Q}}{n} \qquad \text{(3-6)}$$

where σ_{Q} is the standard deviation of Q and n is the number of pixels in the width of the field. In this example, K=4.21.

As mentioned, a region is classifed as a hypothetical casting defect if its feature values lie between certain values. This step must ensure the segmentation of true casting defects. However, a number of erroneous detections is not taken into account.

A hypothetical casting defect is then classified if:

the area size (A) is between 15 and 550 pixels, AND

the roundness (R) is greater than 0.2, AND

the average of the gray values (G) is less than 250 AND

the average of the gradients at the limit (H) is greater than 1 AND

the contrast (K) is greater than 0.1.

These threshold values have been set by trial and error .

The two steps of the algorithm for segmenting hypothetical casting defects are illustrated in FIG. 3.7 in the case of a real X-ray image. In the method of the invention, it is possible that not all the true casting defects in the sequence images will be segmented. This is the case with a defect which lies at the edges of a constructive structure in the test piece. In this case, all the edges of the fault will not be detected, the defect will therefore not be closed and therefore not segmented. In addition, concealment of a very small defect may occur if it is located in a thick cross section of the cast part, in which the X-ray radiation is absorbed very strongly. However, if a defect is segmented in four or more (not necessarily consecutive) X-ray images, it can most probably be tracked and detected. An example of this segmentation method is shown in FIG. 3.8 (see black regions).

Tracking hypothetical casting defects proceeds as follows:

In order to separate between true casting defects and erroneous detections, an attempt is made after segmentation to track the hypothetical casting defects in the image sequence. Tracking comprises three steps: matching in two images, tracking in a plurality of images and verification. Before these steps are carried out, the projection matrices and the multifocal tensors are calculated.

Since the X-ray images are recorded at N different positions of the test piece, an index p, p=1, . . . , N, is used to designate the position of the test piece.

The projection of a 3D point X at the position p of the test piece is designated in the X-ray image as the pixel uₚ=[uₚ vₚ 1]^{T}.

Using the recorded position variables (\overline{X}₀,\overline{Y}₀,\overline{Z}₀)ₚ and (ωₓ, ω_{y}, ω_{z})ₚ, the projection matrices Pₚ, p=1, . . . , N, are calculated by means of equation (2-2).

The multi-image tensors may be determined from the projection matrices Pₚ [7, 11].

Next, matching in two images is performed. A segmented region can be viewed as the projection of a 3D casting defect onto the image plane. Since a 3D casting defect can be projected on various images in the sequence, regions from different X-ray images can correspond to one another. The corresponding regions are projections of one and the same 3D casting defect. In this step, an attempt is made to connect corresponding regions of two images.

For the purpose of matching of regions in two images, the position of the regions and their extracted feature values are required. In this study, the segmented region a of the pth image in the sequence is designated a=(a, p). It is assumed that the sequence is composed of N images (1≦p≦N) and nₚ regions in the pth image have been segmented (1≦p≦N) . The position and the feature values of the region a=(a, p) are assigned to a position vector X^{a}ₚ and feature vector w^{a}ₚ, respectively.

Assumed as the position of a region are the coordinates of its center of gravity, which are transformed into the projection coordinate system by means of equation (2-4). The position vector then becomes

x^{a}ₚ=[x^{a}ₚy^{a}ₚ1]^{T} (4-1)

The feature vector contains n extracted and normalized feature values from the region:

w^{a}ₚ=[w^{a}ₚ(1)w^{a}ₚ(2) . . . w^{a}ₚ(n)]^{T} (4-2)

This step connects two regions to each other, specifically region a=(a, p) and region b=(b, q), for p≢q, if they satisfy all the following criteria:

a. Epipolar condition: The centers of gravity of the regions must satisfy the epipolar condition [4]. In order to check whether the centers of gravity of the regions x^{a}ₚ and x^{b}_{q} satisfy the epipolar conditions, the criterion used is that the perpendicular euclidic distance between the epipolar straight lines of the point x^{a}ₚ in the qth image and the point x^{b}_{q} must be less than ε₂:

$$\frac{\vert {x}_{q}^{bT} {F}_{pq} {x}_{p}^{a} \vert}{\sqrt{{λ}_{x}^{2} + {λ}_{y}^{2}}} < {ϵ}_{2} \qquad \text{(4-3)}$$

where [λₓ λ_{y} λ_{z}]^{T}=F_{pq} x^{a}ₚ. Here, F_{pq} is the so-called 3×3 fundamental matrix, whose elements are the bifocal tensor [7, 11].

b. Similarity criterion: The regions must be similar enough. The measure of similarity used is the euclidic distance between the feature vectors of the regions. The measure of similarity S of the regions must be less than εₛ:

$$S ( {w}_{p}^{a} , {w}_{q}^{b} ) = \sqrt{{\sum }_{i = 1}^{n} {[ {w}_{p}^{a} ( i ) - {w}_{q}^{b} ( i ) ]}^{2}} < {ϵ}_{s} \qquad \text{(4-4)}$$

Here, the features defined in Section 3.2.2.1 are used.

c. Correct localization in the 3D space: The reconstructed 3D point, which is estimated from the centers of gravity of the regions, must lie within the space of the test piece. The corresponding 3D point X is calculated by means of the linear method of Hartley [8] from the centers of gravity x^{a}ₚ and x^{b}_{q}. A check is made as to whether x lies in the test piece, whose dimensions are normally known a priori (for example a wheel is assumed to be a cylinder).

The satisfaction of the three criteria a-c is checked in every two regions a=(a, p) and b=(b, g) in three consecutive images in the sequence, for p=1, . . . , N−3; q=p+1, . . . , p+3; a=1, . . . , nₚ and b=1, . . . , n_{q}.

With the aid of these method steps according to the invention, the aforementioned problems in segmentation (non-segmented or concealed casting defects) can be solved in the tracking step, if a casting defect is not segmented in consecutive images.

If a hypothetical casting defect is not connected to any other, it is classified as an erroneous detection. Many connections are permitted, that is to say a region may be connected to more than one region.

According to this method, the true casting defects are successfully tracked, and very many erroneous detections are eliminated. The example is shown in FIG. 4.1.

The example shown in FIG. 4.2 permits matching in two images to be clarified. Starting from a segmented region (1, p) of the sequence image p, all the segmented regions of the next three sequence images, p+1, p+2 and p+3 are examined as possible successors. In this case, only the regions (1,p+1), (2,p+1); (1,p+2), (2,p+2) and (1,p+3) satisfy the epipolar condition. In addition, the similarity criterion is not satisfied by the region (1,p+1), since its area size is too small as compared with the corresponding feature in region (1,p). Since the region (1,p+2) is much darker than the region (1,p), this does not satisfy this criterion either. In addition, the reconstructed 3D points of these connections belong to the space of the test piece. It follows from this that the possible trackers of the region (1,p) are the regions (2,p+1), (2,p+2), and (1,p+3).

Tracking in a plurality of X-ray images will be explained in the following text. A connection between two regions a and b is designated as a→b or (a,p)→(b,g) . An m₂×4 matrix A=[aᵢ₁ aᵢ₂]=[(aᵢ, pᵢ) (bᵢ, qᵢ)], i=1, . . . , m₂ is defined, where m₂ is the number of connected regions in two images.

Tracking in Three Images

During tracking, trajectories of regions in the image sequence are looked for. The regions must correspond to one another. Starting from the initially determined connections of two regions, it is possible to examine whether there are trajectories with three regions whose centers of gravity are the projections of one and the same 3D point. One looks for all the possible connections of three regions in the matrix A which satisfy the correspondence condition in three images. The columns i and j of the matrix A are determined (for i,j=1, . . . m₂ and i≢j) , where

aᵢ₁=aⱼ₂ (4.5)

If the columns i=I and j=J satisfy the condition (4.5), for example

A_{J}=[(a,p) (b,q)] and

A_{I}=[(b,g)(c,r)],

three corresponding regions with coordinates x^{a}ₚ, x^{b}_{q} and x^{c}ᵣ are found if

∥\hat{x}ᵣ^{c}−xᵣ^{c}∥<ε₃ (4.6)

where \hat{x}ᵣ^{c} is the estimate of the coordinates in the third region, which are calculated from the coordinates of the first two regions x^{a}ₚ and x^{b}_{q} by means of the so-called tri-linearities of Shashua or the trifocal conditions [16, 8], with the aid of the trifocal tensors.

The regions which cannot be tracked in three images are classified as erroneous detections and therefore eliminated. The connected m₃ triplets are assigned to a new m₃×6 matrix B=[bₖ₁ bₖ₂ bₖ₃], k=1, . . . , m₃. FIG. 4.3 shows the connections in three images, which are determined in our example.

Tracking in Four Images

The same method is repeated in order to make it possible to find trajectories with four regions. Quadruplets are looked for which satisfy the condition of correspondence in four images. One determines the columns i of the matrix A and the columns k of the matrix B, for i=1, . . . , m₂ and k=1, . . . , m₃, where

aᵢ₁=bₖ₃ (4.7)

If the columns i=I and k=K satisfy the condition (4.7), for example

B_{K}=[(a,p)(b,q)(c,r)] and

A₁=[(c,r)(d,s)],

four corresponding regions with coordinates x^{a}ₚ, x^{b}_{q}, x^{c}ᵣ and x^{d}ₛ are found if

∥\hat{x}ₛ^{d}−xₛ^{d}∥<ε₄ (4.8)

that is to say if the euclidic distance between the estimate of the coordinates in the fourth region \hat{x}ₛ^{d} and its actual coordinates x^{d}ₛ is less than ε₄. In order to estimate \hat{x}ₛ^{d}, the quadrifocal conditions are used, with the aid of the quadrifocal tensors [7, 11].

The quadruplets found are stored in a new m₄×8 matrix C=[c₁₁ c₁₂ c₁₃ c₁₄], 1=1, . . . , M₄. The result in our example is shown in FIG. 4.4. From our experience, a replication of this method for five images can lead to the elimination of the true casting defects.

The trajectories can be simplified as follows. A casting defect which appears in more than four X-ray images can form a plurality of quadruplets. For example: the regions

(1,2)→(1,3)→(4,5)→(2,6)

and the regions

(1,2)→(1,3)→(4,4)→(2,6)

are trajectories of the same casting defect. A simplification leads to:

(1,2)→(1,3)→(4,4)→(4,5)→(2,6).

Such corresponding trajectories can be combined into a single trajectory, which consists of more than four regions. The result in our example is shown in FIG. 4.5. It can be seen that there is an erroneous detection (see small defect).

The verification will be outlined below: A trajectory represents the connections of a hypothetical casting defect along the image sequence. If the term subsequence of a defect is defined as the images in the sequence in which the defect is present, then a trajectory is sometimes interrupted in its subsequence. This is based on the fact that the defect cannot always be segmented in its entire subsequence.

From each trajectory found in the previous step, with the aid of a least-squares method [3], the corresponding 3D point X is estimated which would produce the centers of gravity of the tracked regions. This 3D point can be projected onto those images in the subsequence in which the segmentation of the defect was not successful. The position of the defect is then known in all the images in the subsequence. Its size can also be estimated as the average of the sizes of the segmented defects.

In all the images in the subsequence, one then determines small windows, which are centered on the centers of gravity (estimated and found) of the regions of the trajectory and whose sizes correspond to the sizes of the defect. These small windows are shown as small rectangles in FIG. 4.5.

A sliding window is calculated as the average of all the small windows belonging to a trajectory. This operation suppresses the quantum noise of the X-ray images. An examination is then made to see whether the contrast of the sliding window is sufficiently high. If this is so, it is assumed that the corresponding hypothetical casting defect of the trajectory is a true casting defect, and the cast part is to be classified as a reject part.

FIG. 4.6 shows the true casting defects which are detected by this method in our X-ray image sequence. The objective is reached: the true casting defects can be separated from the erroneous detections.

The experimental results which were obtained during the automatic inspection of a branded aluminum wheel by applying the method described will now be presented. These results were achieved with real and semisynthetic X-ray images.

The parameters of the method, which were set manually, were σ=1.25 pixel (for the LoG mask), εₛ=0.7, ε₂=0.75 mm, ε₃=ε₄=0.9 mm. These parameters remained unchanged in our investigations. It was assumed that the aluminum wheel was a cylinder with the following dimensions: 200 mm height and 470 mm diameter. The distance between X-ray source and image amplifier (optical distance) was 884 mm.

Fourteen real X-ray image sequences of an aluminum wheel with known casting defects were examined. The casting defects were produced by boring small holes (Ø=2.0˜7.5 mm) in positions of which it was known that they are difficult to detect. There were casting defects only in the first seven image sequences.

The results are summarized in table 5.1 and in FIG. 5.1. During the segmentation, the misclassification was 98.4% (4310/4381). The efficiency of this step was considerable, however, since 84.5% (71/84) of the projected casting defects were segmented. It can be seen that the erroneous detections can be eliminated in the next steps, while the true casting defects were detected successfully in every case.

In order to investigate the throughput of the method according to the invention in critical cases, semisynthetic X-ray images were processed. A simple 3D model of a casting defect (a spherical bubble) was introduced into real X-ray images of an aluminum wheel with the aid of the absorption law [10].

In this trial, the artificial casting defects were projected onto ten X-ray images of a real aluminum wheel. The position of this casting defect was selected in such a way that it overlapped one edge of the structure during the projection. 24 such positions in the area illustrated in FIG. 5.2a were examined. This trial was repeated for various sizes (Ø=1.5˜7.5 mm) (see FIG. 5.2b).

The results can be seen in FIG. 5.2c. The number of erroneous detections is always zero. The detection is perfect for Ø≧2.5 mm, and greater than 95% for Ø≧2.1 mm. However, segmentation is unsuccessful when a very small casting defect lies exactly on the edge of a structure. In this case, a smaller parameter a in the LoG mask of the edge detection could be selected, but unfortunately this would increase the number of erroneous detections. Other noncritical trials, in which the aforementioned difficulty was not present, led to perfect detections (100% true detections and 0% erroneous detections).

The method according to the invention is very efficient, since it comprises two fundamental steps: segmentation and tracking, it being possible to set the calibration once and maintain it, if neither the testing system nor the camera have their location changed. The basic idea was to imitate the manner in which a human tester examines X-ray images for material defects: first of all he detects relevant details and then tracks them in the image sequence.

In the method according to the invention, first of all hypothetic casting defects are segmented in each X-ray image of the sequence. An attempt is then made to track them in the image sequence. The erroneous detections of the hypothetical casting defects may be eliminated well, since they cannot be tracked. On the other hand, the true casting defects in the image sequence can be tracked successfully, since they are located at positions which satisfy geometric conditions.

The great advantage of the first step is the application of a single filter to the segmentation of hypothetical casting defects, said filter being independent of the constructive structure of the test piece.

In addition, the second step of the method according to the invention:

a) is very efficient in eliminating erroneous detections and, at the same time, in tracking the true casting defects, and

b) is very quick because of the application of the multi-image tensors.

The use of the method according to the invention can be performed in industry, since the constituent parts were tested in a laboratory prototype, and the preliminary results are very promising.

The present invention was described with a view to determining casting defects. However, it should readily be clear to those skilled in the art that it can be used to the same extent for determining material defects per se. For example, one can think here of welding faults, and material defects of tires and other plastic articles.

Literature References

[1] Boerner, H.; Strecker, H ,: “Automated X-Ray Inspection of Aluminum Casting”, IEEE Trans. Pattern Analysis and Machine Intelligence, 10(1) :79-91, 1988.

[2] Castleman, K. R.: “Digital Image Processing”, Prentice-Hall, Englewood Cliffs, N.J. 07632, 1996.

[3] Faugeras, O.: “Three-Dimensional Computer Vision: A Geometric Viewpoint”, The MIT Press, Cambridge Mass., London. 1993.

[4] Faugeras, O.; Mourrain, B.: “On the geometry and algebra of the point and line correspondences between N images”, in ₅th, ICCV, Cambridge, Mass., 951-956. 1995.

[5] Faugeras, O.; Papadopoulo, T.: “A nonlinear method for estimating the projective geometry of 3 views”, ICCV 98, pp. 477-484, Bombay, India, January 1998.

[6] Filbert, D.; Klatte, R.; Heinrich, W.; Purschke, M.: “Computer aided inspection of castings”, In IEEE-IAS Annual Meeting, Atlanta, USA, 1087-1095, 1987.

[7] Hartley, R.: “Multilinear Relationships between Coordinates of Corresponding Image Points and Lines”, Proceedings of the International Workshop on Computer Vision and Applied Geometry, International Sophus Lie Center, Nordfjordeid, Norway, August 1995.

[8] Hartley, R.: “Lines and Points in Three Views and the Trifocal Tensor”. International Journal of Computer Vision, 22(2): 125-150, 1997.

[9] Hecker, H.: “Ein neues Verfahren zur robusten Röntgenbildauswertung in der automatischen Gussteilprüfung” [A new method for robust X-ray image evaluation in the automatic testing of cast parts], Dissertation at the Institute for General Electrotechnology, Technical University of Berlin, 1995.

[10] Heinrich, W.: “Automatische Röntgenserienprüfung von Gussteilen” [Automatic mass X-ray testing of cast parts], Dissertation at the Institute for General Electrotechnology, Technical University of Berlin, 1988.

[11] Heyden, A.: “A Common Framework for Multiple View Tensor”, European Conference on Computer Vision (ECCV′98), 3-19, Freiburg, Germany, Jun. 2-6, 1998.

[12] Mery, D.; Filbert, D.: “Epipolar Geometry in Radioscopic Images”, Computerized Tomography for Industrial Applications and Image Processing in Radiology, DGZfP Proceedings BB 67-CD: 181-187, Mar. 15-17, 1999, Berlin, Germany.

[13] Mery, D.; Filbert, D.: “Verfolgung von Gussfehler in einer digitalen Roentgenbildsequenz—Eine neue Methode zur Automatisierung der Qualitätskontrolle von Gussteilen” [Tracking casting defects in a digital X-ray image sequence—a new method for automating the quality inspection of cast parts], XIII. Meβtechnik Symposium des Arbeitskreis der Hochschullehrer fuer Meβtechnik e.v., AHMT, 30. Sep. 30-Oct. 2, 1999, Hannover, Germany.

[14] Mery, D.; Filbert, D.; Krüger, R.; Bavendiek, K.: “Automatische Gussfehlererkennung aus monokularen Bildsequenzen” [Automatic casting fault detection from monocular image sequences], annual meeting of the DGZfP, (1):93-102, May 10-12, 1999, Celle, Germany.

[15] Purschke M.; Schulenburg H.: “Fortschritte der vollautomatischen Röntgenprütfung” [Progress in fully automatic X-ray testing], annual meeting of the Deutschen Gesellschaft für Zerstörungsfreie Prüfung [German Association for nondestructive testing], annual meeting, 309-317, Bamberg, Sep. 7-9, 1998.

[16] Shashua, A.: “Trilinear Tensor: The Fundamental Construct of Multiple-view Geometry and its Applications”. International Workshop on Algebraic Frames For The Perception Action Cycle (AFPAC), Kiel Germany Sep. 8-9, 1997.

[17] Wenzel, T.; Hanke, R.: “Fast image processing on die castings”, Anglo-German Conference on NDT Imaging and Signal Processing, Oxford, 27-28 Mar. 27-28, 1998.

[18] Zhang, Z.: “On the Epipolar Geometry Between Two Images With Lens Distorsion”, in Proc. Int. Conference Recognition (ICPR), Vol. I, pages 407-411, August 1996, Vienna.

1. A method for automatically detecting casting defects in a test piece by means of a testing system, comprising an X-ray radiation device, manipulator, image amplifier and image processing computer, in which, during the movement of the test piece, N X-ray images are recorded, each X-ray image corresponding to one position of the test piece and, together with the respective image, being stored in digitized form, and hypothetical defects (areas) in each image being looked for, segmented and extracted with regard to their features and stored, and the hypothetical defects (areas) in two or more images being tracked and analyzed in accordance with the criteria of geometric projections, characterized by
a. calibration by measuring the geometry of the testing system and estimating the geometric transformation between a 3D point of the test piece and a 2D pixel of the X-ray image,
b. recording and storing the translational and rotational position variables of the test piece at the instant of each recording by using a projection coordinate system, which is calculated via the position of the manipulator,
c. calculating and storing the geometric parameters from the position registered under b) and the parameters from the calibration under a) which are needed for a correspondence search in two or more images,
d. segmenting hypothetic casting defects in each recording, extracting and storing the feature values from each segmented hypothetical casting defect, which characterize its properties quantitatively,
e. determining the coordinates of the center of gravity of the hypothetical casting defects and transforming these coordintes into a new coordinate system to eliminate any distortions,
f. tracking the hypothetical casting defects in the image sequence, a so-called matching of two images, by two regions which satisfy the bifocal condition, the similarity condition and the 3D localization condition being connected to each other,
g. sorting out the erroneous detections which do not satisfy the bifocal condition, the similarity condition and the 3D localization condition,
h. tracking the remaining hypothetical, casting defects in the image sequence, so-called tracking of 3 and 4 images being carried out by three or four regions which satisfy the trifocal or quadrifocal condition being connected to one another,
i. sorting out the hypothetical erroneous detections which do not satisfy the multifocal conditions,
j. analyzing the previously determined results by defining a 3D point from the centers of gravities of the tracked regions of a trajectory, projecting this 3D point into the X-ray images in which the tracked hypothetical casting defects were not segmented, considering the same as windows, examining the contrast by using a threshold value which, if exceeded, defines a true casting defect.

2. The method as claimed in claim 1, characterized by calculating and storing the projective matrices Pₚ, for p=(1 . . . N), from each recording from the position registered under b.) and the parameters of the calibration under a.) as stage c1).

3. The method as claimed in claim 1, characterized by calculating the multifocal tensors from the projective matrices as stage c2).

4. The method as claimed in claim 1, characterized by searching for erroneous areas formed by edges, by means of the extraction, classification and storage of the following features
Area size (A),
Roundness or shape factor (R),
Average of the gray values (G),
Average of the gradients at the limit (H), and
Contrast (K)
as stage d).

5. The method as claimed in claim 1, characterized in that at stage d), a hypothetical casting defect is classified if
the area size (A) is between 15 and 550 pixels, AND
the roundness (R) is greater than 0.2, AND
the average of the gray values (G) is less than 250, AND
the average of the gradients at the limit (H) is greater than 1, AND
the contrast (K) is greater than 0.1,
these threshold values being set by trial and error.

6. The method as claimed in claim 1, characterized in that in stage d) A represents the area of the region,
$$R = \frac{4 π A}{{L}^{2}} ,$$
where L represents the circumference of the region, and
$$G = \frac{1}{A} {\sum }_{i , j ∈ ℜ} {g}_{ij} ,$$
where gᵢⱼ is the gray value of the pixel (i,j) and R forms the pixel set of the region, and H=
$$\frac{1}{L} {\sum }_{i , j ∈} {g}_{ij}^{′} ,$$
where g′ᵢⱼ is the gradient (1^{st} derivative) of the gray value of the pixel (i,j), and λ forms the pixel set of the limit, and where K represents a measure of the blackening difference between the region and its surroundings.

7. The method as claimed in claim 1, characterized in that in stage e) the coordinates of the projection plane are calculated in accordance with the following formulas
$$[ \begin{matrix}{u}^{′} \\ {v}^{′} \\ 1\end{matrix} ] = {[ \begin{matrix}{k}_{x} cos ( α ) & {k}_{y} sin ( α ) & {u}_{0} \\ - {k}_{x} sin ( α ) & {k}_{y} cos ( α ) & {v}_{0} \\ 0 & 0 & 1\end{matrix} ]}^{- 1} [ \begin{matrix}u \\ v \\ 1\end{matrix} ]$$
$$x = \frac{{u}^{′}}{\sqrt{1 + {[ \frac{{u}^{′}}{a} ]}^{2} + {[ \frac{{v}^{′}}{b} ]}^{2}}} and y = \frac{{v}^{′}}{\sqrt{1 + {[ \frac{{u}^{′}}{a} ]}^{2} + {[ \frac{{v}^{′}}{b} ]}^{2}}} ,$$
In this case (u,v) are the coordinates of the center of gravity of the hypothetical casting defect in the X-ray image and (x,y) are the transformed coordinates, the parameters a, b, kₓ, k_{y}, α, u₀ and v₀ being estimated from correspondence points by a gradient method.

8. The method as claimed in claim 1, characterized in that the measure of similarity required in stage g) is formed by the euclidic distance between the feature vectors of the regions, it being necessary for the measure of similarity S of the regions to be smaller than εₛ:
$$S ( {w}_{p}^{a} , {w}_{q}^{b} ) = \sqrt{{\sum }_{i = 1}^{n} {[ {w}_{p}^{a} ( i ) - {w}_{q}^{b} ( i ) ]}^{2}} < {ϵ}_{s}$$
and in this case w^{j}ₖ=[w^{j}ₖ(1) . . . w^{j}ₖ(n)]^{T}, where w^{j}ₖ (i) is the ith feature value of the jth region in the kth image.

9. The method as claimed in claim 1, characterized in that after being tracked in four images, a casting defect is tracked twice and the repeated trajectories are combined into a longer trajectory.

10. The method as claimed in claim 1, characterized in that the results of the matching and tracking of stages f) and h) are stored in individual tables.
